(19) United States
(12) Patent Application Publication
(10) Pub. No.: US 2019/0277342 A1
(43) Pub. Date: Sep. 12, 2019

(54) SHAFT ASSEMBLY AND AIRCRAFT ENGINE WITH A SHAFT ASSEMBLY

(71) Applicant: Rolls-Royce Deutschland Ltd & Co KG, Blankenfelde-Mahlow (DE)

(72) Inventor: Bjoern PETERSEN, Berlin (DE)

(21) Appl. No.: 16/291,565

(22) Filed: Mar. 4, 2019

(30) Foreign Application Priority Data
Mar. 7, 2018 (DE) 10 2018 203 423.0

(51) Int. Cl. F16D 3/54; F16D 49/02; F16D 3/10; F16D 3/62

(52) U.S. Cl. CPC F16D 3/54; F16D 3/62; F16D 3/10; F16D 49/02

(57) ABSTRACT

A shaft arrangement with two concentrically arranged shafts, in particular two concentric hollow shafts that are coupled to the drive side or the output side of an engine, wherein the shafts respectively have envelope elements that are connected to at least one elastically bending connection element, wherein the torque transmission between the concentric shafts is effected by tensile forces in the elastically bending envelope elements. The invention also relates to an aircraft engine with such a shaft arrangement.

This application claims priority to German Patent Application DE102018203423.0 filed Mar. 7, 2018, the entirety of which is incorporated by reference herein.

The present invention relates to a shaft arrangement for connecting two shafts having the features of claim 1 and an aircraft engine with a shaft arrangement having the features of claim 20.

Via drive and output shafts of an engine, transverse forces and/or bending moments are also always transmitted, which are generally undesirable due to the mechanical load of the gear. These loads can e.g. entail problems regarding tooth meshing in the gear. One field of application for gears is in fan gear engines for aircrafts, for example. The planetary gears that are usually used therein are embodied as a reduction gear configured to reduce the rotational speed of a fan as compared to a driving turbine.

There is the objective to provide shaft arrangements that can minimize a mechanical load on the engine.

This objective is achieved by means of a shaft arrangement according to claim 1.

This shaft arrangement serves for connecting two concentrically arranged shafts, in particular two concentric hollow shafts. The shafts are coupled to the drive side or the output side of an engine, with the shafts respectively having envelope elements that are connected to at least one elastically bending connection element, wherein the connection of the concentric shafts is effected by tensile forces in the elastically bending envelope elements. The at least one elastically bending connection element is coupled with the envelope elements in an alternating manner, e.g. by being guided around the envelope elements; thus, the envelope elements have the role of a fixed deflection pulley. The winding of the at least one connection element around the envelope elements can also be understood to be a braiding which leads to a connection of the shafts.

Regarded in an idealized manner, elastically bending connection elements only receive tensile forces and doe neither transmit bending moments nor transverse forces as soon as the length of the connection element considerably exceeds its thickness.

The partial sections of the at least one connection element are arranged in such a manner between the envelope elements that due to their tensile forces the torque of the one shaft is transmitted to the other.

If now transverse forces and bending moments are applied at a shaft, the length of the partial section of the connection element changes as a result of the connection element sliding through at the envelope elements. However, no forces and moments are transmitted.

In one embodiment, the at least one elastically bending connection element is formed as a rope, in particular as a wire rope, as a chain, or as a strap. All these means are also suited for transmitting high tensile forces. Here, the at least one elastically bending connection element can in particular be formed in a ring-shaped manner.

For connecting the shafts, the at least one elastically bending connection element can be guided around and/or wound around the envelope elements. Here, in order to minimize the friction, the at least one elastically bending connection element can be arranged at the envelope elements without being crossed with itself or with other elastically bending connection elements.

The at least one connection element can be fixated maximally at one position at an envelope element. Further fixations do no longer allow the connection element to slide through, and thus again transmit undesired transverse forces and bending moments.

In a further embodiment, the at least one elastically bending connection element, in particular in the loaded state, is arranged in a plane that is perpendicular to the rotational axis of the two concentric shafts in order to connect the concentric shafts. In this manner, it can be achieved that a torque is transmitted from the one shaft to the other in a manner that is as coaxial as possible.

It is also possible for the envelope elements to be arranged in such a manner at the concentric shafts that the at least one elastically bending connection element coupled therewith is arranged in a plane that is perpendicular to the rotational axis of the two concentric shafts.

Thus, the envelope elements can for example be arranged in the axial direction as projections at least at one of the concentric shafts, wherein the projections are in particular formed in one piece at the shaft ends. The elastically bending connection element can be wound around the projections, e.g. with a rounded cross section.

The envelope elements can e.g. be at least partially formed as openings, in particular as pairs of openings in the concentric hollow shafts. The at least one elastically bending connecting means can be braided through these openings. It is also possible to combine differently designed envelope elements with each other.

Here, it is also possible that the at least one elastically bending connection element is formed as a mechanical securing device if a certain tensile load is exceeded. In this way, it is e.g. possible to avoid or minimize any damage to surrounding components.

It is also possible that at least two elastically bending connection elements are arranged so as to be axially displaced with resect to one another; i.e. they can e.g. be arranged in planes that are displaced in parallel axially. In particular, the at least two elastically bending connection elements can have different tensile elasticities, so that the stiffness of the shaft arrangement can be adjusted to the load situation.

For typical structural designs, such as they are e.g. used in fan gear engines, between 5 and 30 envelope elements, in particular 10 envelope elements, can be arranged at the concentric shafts at the circumference or at the shaft end. In this manner, a sufficient braiding of the shaft through the at least one elastically bending connecting means can be achieved.

In one embodiment, the shaft arrangement connects two concentric shafts on the output side of an engine, in particular on the output side of a planetary gear of a turbofan drive.

In another embodiment, the shaft arrangement connects two concentric shafts on the drive side of an engine, in particular on the drive side of a planetary gear of a turbofan drive.

For axially affixing the at least one elastically bending connection element, the envelope elements can have means for axial affixing (e.g. an end stop or a disc) of the at least one elastically bending connection element.

Further, it is possible that the at least one elastically bending connection element and/or the envelope elements have a low-friction coating.

In a further embodiment, the at least one envelope element has at least one slide bearing. In this way, friction [and] wear at the at least one connection elements is reduced.

For use in an aircraft engine, the at least one elastically bending connecting means can be formed as a wire rope, wherein the wire rope has a diameter of between 5 and 25 mm, in particular of between 10 and 20 mm.

The objective is achieved through an aircraft engine with the features of claim 20.

As noted elsewhere herein, the present disclosure may relate to a gas turbine engine, such as for example an aircraft engine. Such a gas turbine engine may comprise a core engine comprising a turbine, a combustion device, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for gear fans that are driven via a gearbox. Accordingly, the gas turbine engine may comprise a gearbox that is driven via the core shaft, with its drive driving the fan in such a manner that it has a lower rotational speed than the core shaft. The input to the gearbox may be directly from the core shaft, or indirectly from the core shaft, for example via a spur shaft and/or spur gear. The core shaft may rigidly connect the turbine and the compressor, such that the turbine and the compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gearbox may be embodied to be driven by the core shaft that is configured to rotate (for example in use) at the lowest rotational speed (for example the first core shaft in the example above). For example, the gearbox may be embodied to be driven only by the core shaft that is configured to rotate (for example in use) at the lowest rotational speed (for example only by the first core shaft, and not the second core shaft, in the example above). Alternatively, the gearbox may be embodied to be driven by one or multiple shafts, for example the first and/or second shaft in the example above.

In a gas turbine engine as described and/or claimed herein, a combustion device may be provided axially downstream of the fan and the compressor (or the compressors). For example, the combustion device may be located directly downstream of the second compressor (for example at the exit thereof) if a second compressor is provided. By way of further example, the flow at the exit to the combustor may be provided to the inlet of the second turbine if a second turbine is provided. The combustion device may be provided upstream of the turbine(s).

The or each compressor (for example the first compressor and the second compressor according to the above description) may comprise any number of stages, for example multiple stages. Each stage may comprise a row of rotor blades and a row of stator vanes, which may be variable stator vanes (i.e. in that their angle of incidence may be variable). The row of rotor blades and the row of stator vanes may be axially offset with respect to each other.

The or each turbine (for example the first turbine and second turbine according to the above description) may comprise any number of stages, for example multiple stages. Each stage may comprise a row of rotor blades and a row of stator vanes. The row of rotor blades and the row of stator vanes may be axially offset with respect to each other.

Each fan blade may have a radial span extending from a root (or hub) at a radially inner gas-washed location, or from a 0% span position to a tip with a 100%. Here, the ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in a closed range bounded by any two values in the previous sentence (i.e., the values may represent upper or lower bounds). These ratios may commonly be referred to as the hub-to-tip ratio. The radius at the hub and the radius at the tip may both be measured at the leading edge (or the axially forwardmost) edge of the blade. The hub-to-tip ratio refers, of course, to the gas-washed portion of the fan blade, i.e. the portion that is located radially outside any platform.

The radius of the fan may be measured between the engine centerline and the tip of a fan blade at its leading edge. The fan diameter (which may generally be twice the radius of the fan) may be greater than (or on the order of) any of: 250 cm (about 100 inches), 260 cm, 270 cm (about 105 inches), 280 cm (about 110 inches), 290 cm (about 115 inches), 300 cm (about 120 inches), 310 cm, 320 cm (about 125 inches), 330 cm (about 130 inches), 340 cm (about 135 inches), 350 cm, 360 cm (about 140 inches), 370 cm (about 145 inches), 380 (about 150 inches) cm or 390 cm (about 155 inches). The fan diameter may be in a closed range bounded by any two of the values in the previous sentence (i.e. the values may represent upper or lower bounds).

The rotational speed of the fan may vary during operation. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range from 1700 rpm to 2500 rpm, for example in the range from 1800 rpm to 2300 rpm, for example in the range from 1900 rpm to 2100 rpm. Purely by way of further non-limitative example, the rotational speed of the fan at cruise conditions for an engine having a fan diameter in the range from 320 cm to 380 cm may be in the range from 1200 rpm to 2000 rpm, for example in the range from 1300 rpm to 1800 rpm, for example in the range from 1400 rpm to 1600 rpm.

In use of the gas turbine engine, the fan (with the associated fan blades) rotates about a rotational axis. This rotation results in the tip of the fan blade moving with a velocity Uₜᵢₚ. The work done by the fan blades on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as the fan tip radius at the leading edge multiplied by the angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (with all units in this paragraph being Jkg⁻¹K⁻¹/(ms⁻¹)²). The fan tip loading may be in a closed range bounded by any two of the values in the previous sentence (i.e. the values may represent upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements, the bypass ratio may be greater than (or on the order of): 10, 10.5, 11, 11.5, 12, 12.5, 13, 13.5, 14, 14.5, 15, 15.5, 16, 16.5, or 17. The bypass ratio may be in a closed range bounded by any two of the values in the previous sentence (i.e. the values may represent upper or lower bounds). The bypass duct may be substantially annular. The bypass duct may be radially outside the core engine. The radially outer surface of the bypass duct may be defined by a nacelle and/or a fan casing.

The overall pressure ratio of a gas turbine engine as described and/or claimed herein may be defined as the ratio of the stagnation pressure upstream of the fan to the stagnation pressure at the exit of the highest pressure compressor (before entry into the combustion device). By way of non-limitative example, the overall pressure ratio of a gas turbine engine as described and/or claimed herein at cruising speed may be greater than (or on the order of): 35, 40, 45, 50, 55, 60, 65, 70, 75. The overall pressure ratio may be in a closed range bounded by any two of the values in the previous sentence (i.e. the values may represent upper or lower bounds).

Specific thrust of an engine may be defined as the net thrust of the engine divided by the total mass flow through the engine. At cruise conditions, the specific thrust of an engine as described and/or claimed herein may be less than (or on the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in a closed range bounded by any two of the values in the previous sentence (i.e. the values may represent upper or lower bounds). Such engines may be particularly efficient as compared to conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of): 160 kN, 170 kN, 180 kN, 190 kN, 200 kN, 250 kN, 300 kN, 350 kN, 400 kN, 450 kN, 500 kN, or 550 kN. The maximum thrust may be in a closed range bounded by any two of the values in the previous sentence (i.e. the values may represent upper or lower bounds). The thrust referred to above may be the maximum net thrust at standard atmospheric conditions at sea level plus 15 deg C. (ambient pressure 101.3 kPa, temperature 30 deg C.), with the engine being static.

In use, the temperature of the flow at the entry to the high pressure turbine may be particularly high. This temperature, which may be referred to as TET, may be measured at the exit to the combustion device, for example immediately upstream of the first turbine vane, which itself may be referred to as a nozzle guide vane. At cruise, the TET may be at least (or on the order of): 1400 K, 1450 K, 1500 K, 1550 K, 1600 K or 1650 K. The TET at cruise may be in a closed range bounded by any two of the values in the previous sentence (i.e. the values may represent upper or lower bounds). The maximum TET in use of the engine may be, for example, at least (or on the order of): 1700 K, 1750 K, 1800 K, 1850 K, 1900 K, 1950 K or 2000 K. The maximum TET may be in a closed range bounded by any two of the values in the previous sentence (i.e. the values may represent upper or lower bounds). The maximum TET may occur, for example, at a high thrust condition, for example at a maximum take-off (MTO) condition.

A fan blade and/or aerofoil portion of a fan blade as described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fiber. By way of further example at least a part of the fan blade and/or aerofoil may be manufactured at least in part from a metal, such as a titanium based metal or an aluminum based material (such as an aluminum-lithium alloy) or a steel based material. The fan blade may comprise at least two regions that are manufactured by using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fiber or aluminum based body (such as an aluminum lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be present in the form of a dovetail that may be inserted into a corresponding slot in the hub/disc and/or may engage with the same in order to affix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow for the exit area of the bypass duct to be varied during operation. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may refer to the cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85, or in the range from 0.8 to 0.85. Any single speed within these ranges may be the cruise condition. For some aircrafts, the cruise conditions may be outside these ranges, for example below Mach 0.7 or above Mach 0.9.

Purely by way of example, the cruise conditions may correspond to standard atmospheric conditions at an altitude that is in the range from 10000 m to 15000 m, for example in the range from 10000 m to 12000 m, for example in the range from 10400 m to 11600 m (around 38000 ft), for example in the range from 10500 m to 11500 m, for example in the range from 10600 m to 11400 m, for example in the range from 10700 m (around 35000 ft) to 11300 m, for example in the range from 10800 m to 11200 m, for example in the range from 10900 m to 11100 m, for example on the order of 11000 m. The cruise conditions may correspond to standard atmospheric conditions at any given altitude in these ranges.

Purely by way of example, the cruise conditions may correspond to the following: a forward Mach number of 0.8; a pressure of 23000 Pa; and a temperature of −55 deg C.

As used anywhere herein, “cruise” or “cruise conditions” may refer to the aerodynamic design point. Such an aerodynamic design point (or ADP) may correspond to the conditions (comprising, for example, one or more of the Mach Number, environmental conditions and thrust requirement) in which the fan is designed to operate. This may mean, for example, the conditions at which the fan (or the gas turbine engine) is designed to have optimum efficiency.

During operation, a gas turbine engine as described and/or claimed herein may operate at the cruise conditions defined elsewhere herein. Such cruise conditions may be determined by the cruise conditions (for example the mid-cruise conditions) of an aircraft to which at least one (for example two or four) of the gas turbine(s) engine may be mounted in order to provide propulsive thrust.

The person skilled in the art will appreciate that, except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Exemplary embodiments are described in connection with Figures, herein:

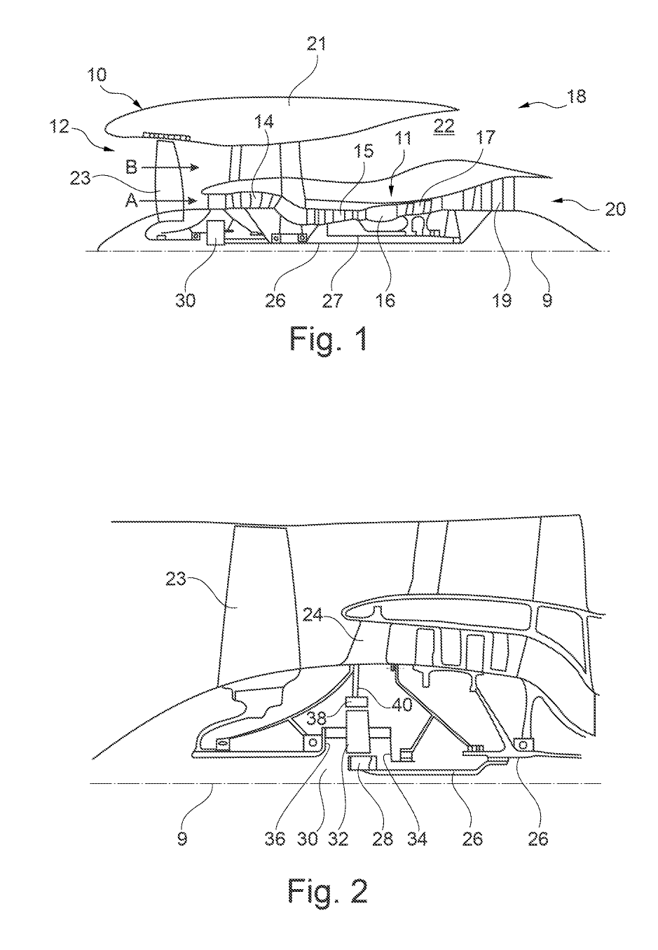

FIG. 1 shows a lateral sectional view of a gear fan engine;

FIG. 2 shows an enlarged view of a lateral sectional view of the front part of the engine according to FIG. 1;

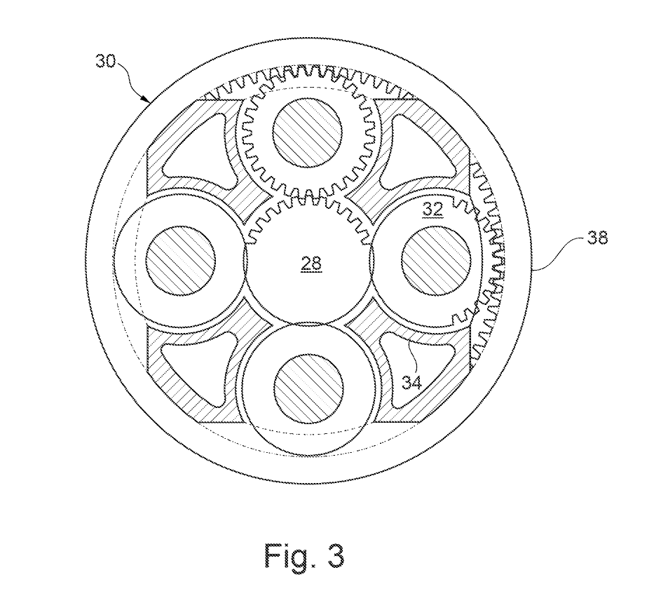

FIG. 3 shows a schematic view of a planetary carrier for planetary wheels;

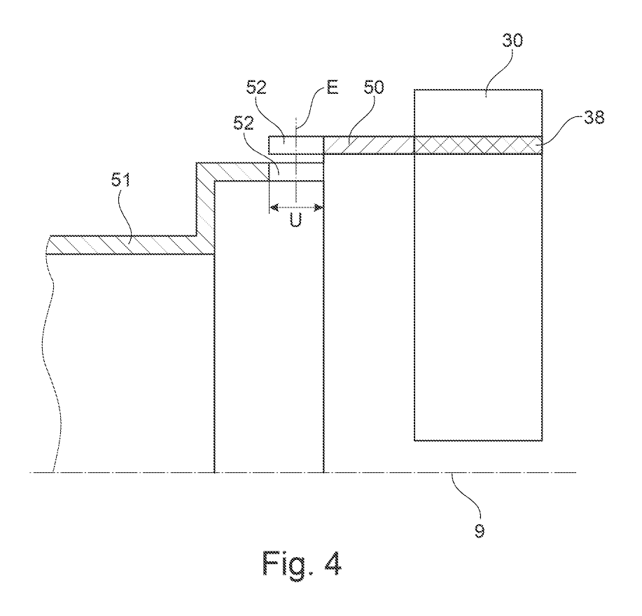

FIG. 4 shows a schematic lateral sectional view through two shafts that are connected to an elastically bending connection element on the drive or output side of an engine;

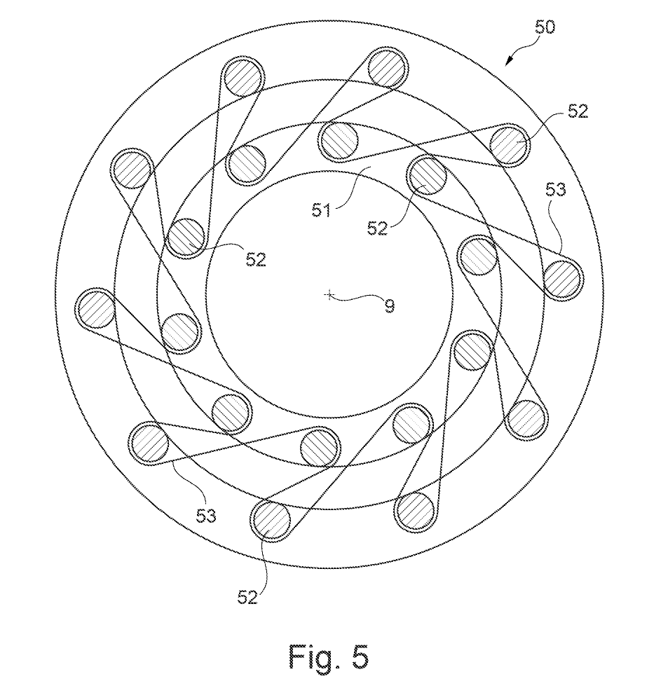

FIG. 5 shows a schematic top view on the elastically bending connection element and the envelope elements establishing the connection between the two shafts;

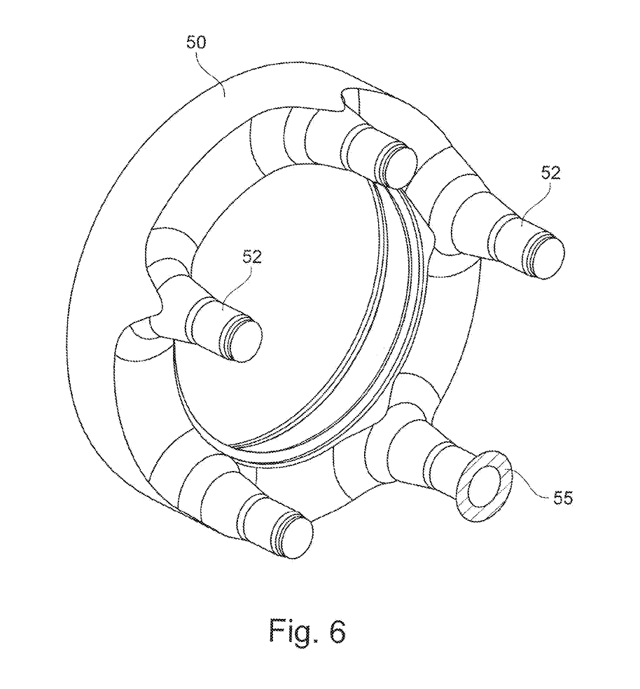

FIG. 6 shows a perspective view of a shaft end with the envelope elements for the flexible connection element;

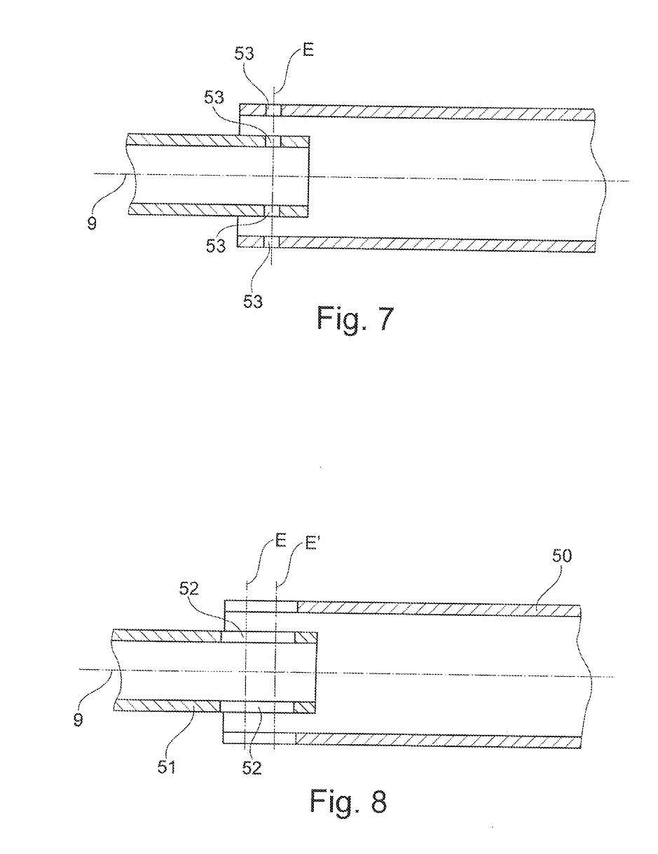

FIG. 7 shows a schematic rendering of a further embodiment of a shaft arrangement;

FIG. 8 shows a schematic rendering of a further embodiment with two elastically bending connecting means that are arranged in parallel.

FIG. 1 describes an aircraft engine 10 having a main rotational axis 9. The engine 10 comprises an air intake 12 and a fan 23 that generates two airflows: a core airflow A through a core engine 11 and a bypass airflow B.

The core engine 11 comprises, as viewed in the axial flow direction, a low pressure compressor 14, a high pressure compressor 15, combustion device 16, a high pressure turbine 17, a low pressure turbine 19 and a core engine exhaust nozzle 20. A nacelle 21 surrounds the aircraft engine 10 and defines the bypass duct 22 (also referred to as the subsidiary flow duct) and a bypass exhaust nozzle 18. The bypass airflow B flows through the bypass duct 22. The fan is driven by the low pressure turbine 19 via the shaft 26 and a planetary gear 30.

During operation, the airflow A in the core engine 11 is accelerated and compressed by the low pressure compressor 14, wherein it is directed into the high pressure compressor 15 where further compression takes place. The air that is discharged from the high pressure compressor 15 in a compressed state is directed into the combustion device 16 where it is mixed with fuel and combusted.

The resulting hot combustion gases are guided through the high pressure turbine 17 and the low pressure turbine 19, which are driven by the combustion gasses. Subsequently, the combustion gasses are discharged through the core exhaust nozzle 20 and provide a portion of the total thrust. The high pressure turbine 18 drives the high pressure compressor 15 via a suitable interconnecting shaft 27. The fan 23 usually provides the greatest portion of the propulsive thrust. In the present case, the planetary gear 30 is embodied as a reduction gear to reduce the rotational speed of the fan 23 as compared to the driving turbine.

An exemplary arrangement for a geared fan arrangement of an aircraft engine is shown in FIG. 2.

The low pressure turbine 19 (see FIG. 1) drives the shaft 26, which is coupled to a sun gear 28 of the planetary gear 30. Located radially outwardly of the sun gear 28 and intermeshing therewith is a plurality of planetary wheels 32 that are coupled with each other by a planet carrier 34. The planet carrier 34 forces the planetary wheels 32 to precess around the sun gear 28 synchronously whilst enabling each planetary wheel 32 to rotate about its own axis. Via connections 36, the planet carrier 34 is coupled to the fan 23 in order to cause its rotation about the rotational axis 9. An annulus or ring gear 38 is connected radially outside of the planetary wheels 32 and intermeshing therewith, and connected via connections 40 to a stationary supporting structure 24. This structural design represents an epicyclic planetary gear 30.

Note that the terms “low pressure turbine” and “low pressure compressor” as used herein may be taken to refer to the turbine stages with the lowest pressure and the compressor stages with the lowest pressure (i.e., not including the fan 23) and/or refer to the turbine and compressor stages that are connected by the interconnecting shaft 26 with the lowest rotational speed in the engine 10 (i.e., not including the gearbox output shaft that drives the fan 23). A “low pressure turbine” and a “low pressure compressor” referred to herein may alternatively also refer to an “intermediate pressure turbine” and an “intermediate pressure compressor”. Where such alternative nomenclature is used, the fan 23 may be referred to as a first or lowest pressure stage.

The planetary gear 30 is shown by way of example in greater detail in FIG. 3, wherein some of the features will be discussed in more detail in connection with the embodiments described herein. The sun gear 28, planetary wheels 32 and the ring gear 38 respectively have teeth at their circumference to intermesh with the other gears. However, for reasons of clarity only exemplary portions of the teeth are illustrated in FIG. 3. Here, four planetary wheels 32 are illustrated, although it will be apparent to the person skilled in the art that more or fewer planetary wheels 32 may be provided within the scope of the claimed invention. Practical applications of a planetary epicyclic gearbox 30 generally comprise at least three planetary wheels 32.

The planetary gear 30 illustrated by way of example in FIGS. 2 and 3 is an epicyclic planetary gear since the planetary carrier 34 is connected in a rotatable manner, i.e. above all in a drivable manner, to the fan 23 via a shaft.

However, it is also possible to use any other suitable type of a planetary gear 30.

By way of further example, the planetary gear 30 may comprise a star arrangement, in which the planet carrier 34 is supported in a fixed manner, and the ring (or annulus) gear 38 is rotatable. In such an arrangement, the fan 23 is driven by the ring gear 38. By way of further alternative example, the gear 30 may be a differential gearbox in which the ring gear 38 as well as the planet carrier 34 are both rotatable.

It will be obvious that the arrangement shown in FIGS. 2 and 3 serves merely as an example, and the scope of the present disclosure also comprises various alternatives. Purely by way of example, any suitable arrangement may be used for locating the planetary gear 30 in the engine 10 and/or for connecting the planetary gear 30 to the engine 10. By way of further example, the connections (such as the connections 36, 40 in the embodiment according to FIG. 2) between the planetary gear 30 and other parts of the engine 10 (such as the core engine shaft 26, the output shaft and the stationary support structure 24) may have any desired degree of stiffness or flexibility.

By way of further example, any suitable arrangement of the bearings between rotating and stationary parts of the engine 10 (for example between the input and output shafts of the planetary gear 30 and the fixed structures, such as for example the gearbox casing) may be used, and the disclosure is not limited to the exemplary arrangement of FIG. 2. For example, where the planetary gear 30 has a star arrangement, the person skilled in the art would readily understand that the arrangement of output and support connections and bearing locations would typically be different from that shown in FIG. 2.

Accordingly, the present disclosure extends to an aircraft engine 10 having any arrangement of gearbox styles (for example star arrangement or planetary arrangements), support structures, input and output shaft arrangement, and bearing locations.

Optionally, the planetary gear 30 may drive additional and/or alternative components (e.g. the intermediate pressure compressor and/or a booster compressor).

Other aircraft engines 10 to which the present disclosure may be applied may have alternative configurations. For example, such aircraft engines 10 may have a different number of compressors and/or turbines and/or a different number of interconnecting shafts. By way of further example, the engine 10 shown in FIG. 1 has a split flow nozzle 20, meaning that the flow through the bypass duct 22 has its own nozzle that is separate from and arranged radially outside of the core engine exhaust nozzle 20. However, this is not to be taken in a limiting manner, and any aspect of the present disclosure may also apply to engines 10 in which the flow through the bypass duct 22 and the flow through the core engine 11 is intermixed or combined by a single nozzle (in front of or upstream), which is referred to as a mixed flow nozzle. One or both nozzles may have a fixed or variable cross section (independently of whether a mixed or a partial flow is present). Whilst the example described herein relates to a turbofan engine, the disclosure may apply, for example, to any type of aircraft engine, such as an engine 10 with an open rotor (in which the fan stage 23 is not surrounded by a housing) or to a turboprop engine, for example.

The geometry of the aircraft engine 10 and its components is defined by a conventional axis system, comprising an axial direction (which is aligned with the rotational axis 9), a radial direction (in the bottom-to-top direction in FIG. 1), and a circumferential direction (perpendicular to the view of FIG. 1). The axial, radial and circumferential directions are mutually perpendicular.

Shown in the following are several embodiments for shaft arrangements in connection with an aircraft engine 10, namely a fan gear engine. As shown in FIGS. 1 and 2, this gear 30 serves for reducing a rotational speed of a driving turbine 19 in such a manner that the fan 23 can be driven with a lower rotational speed. Here, different shafts 50, 51 have to be connected to each other on the drive and output side of the gear 30.

One embodiment for connecting two shafts 50, 51 on the drive or the output side is shown schematically in FIG. 4. The drive is effected via the planetary carrier 38, which is shown here symbolically. The first shaft 50 is connected to the planetary carrier 38, so that the torque is ultimately transmitted to the fan 23 via the shaft arrangement (see FIG. 2). This transmission occurs via the second shaft 51 that is arranged concentrically with respect to the first shaft 50.

In this exemplary embodiment, concentrically means that the two shafts 50, 51 have a common rotational axis 9. Also, the second shaft 51 has a smaller diameter at the drive end than the first shaft 50; the two shaft ends overlap over a certain distance (overlapping area U).

In another embodiment, the shaft arrangement can also be embodied so as to overlap in exactly the opposite manner, i.e. the first shaft 50 has a smaller diameter than the second shaft 51.

In the overlapping area U, the two concentric shafts 50, 51 are connected to each other via an elastically bending connection element 53, which will be described in more detail in FIG. 5.

FIG. 5 shows the sectional view of the shaft arrangement in a plane E (see FIG. 4). Here, the shaft end of the first shaft 50 concentrically surrounds the shaft end of the inner, second shaft 51. For better rendering in the drawing, the radial distance between the shafts 50, 51 is shown in an enlarged manner.

Arranged at the respective shaft ends of the shafts 50, 51 are ten projections by way of envelope elements 52, with the elastically bending connection element 53 being wound around them. As shown in FIG. 5, here the elastically bending connection element 53 is wound about the envelope elements 52 alternatingly on the inner shaft 51 and the outer shaft 52. At that, the elastically bending connection element 53 can also be slightly pre-stressed. Thus, e.g. a spring element that is arranged at one of the shafts 50, 51 can press on the elastically bending connection element 53 in a spring-loaded manner.

In this embodiment, the envelope elements 52 overlap in the overlapping area U.

Here, the envelope elements 52 are formed as projections that extend in the axial direction of the shaft 50, 51. FIG. 6 shows a one-piece connection of the envelope elements 52 with a shaft end, wherein only six envelope elements are provided in the present case.

Here, the elastically bending connection element 53 is formed as a wire rope that in general can only transmit tensile forces. At that, the wire rope is embodied as a ring that is guided around the envelope elements 52 of the shafts 50, 51 without any crossing.

If the fan 23 transmits transverse forces and/or bending moments via the second shaft 51 in the direction of the gear 30, they cannot overcome the shaft arrangement with the elastically bending connection element 53. The latter forms an elastic shaft coupling through the rope bracing, so that no transverse forces or bending moments can be transmitted to the gear 30. Here, the rope-shaped connection element 53 can only transmit tensile forces that are located within the plane E.

The driving torque of the first shaft 50 causes the tensile forces from the envelope elements 52 of the first shaft 50 to act on the envelope elements 52 of the second shaft 51. These applied tensile forces are then translated into a torque for the second shaft 51 and ultimately the fan 23. Here, the torque transmission occurs in a plane E that is perpendicular to the rotational axis 9.

In general, any rope elongation that may possibly occur due to use and/or temperature is not harmful for the efficient transmission of the torque, since only the radial angular position of the concentric shafts 50, 51 changes in the case of elongation.

In the exemplary embodiment shown here, a ring-shaped wire rope is used as the elastically bending connection element 53. In general, also two or more wire ropes can be wound around the envelope elements 52. The wire rope can have a diameter of 10 to 25 mm, e.g. 15 mm. The strength is sufficient to transmit the high torques during output or also during drive of the gear.

Here, it can also be expedient to provide the elastically bending connection elements 53 and/or the envelope elements 52 with a low-friction coating.

It is also possible that the elastically bending connection element 53 is formed as a strap or a chain, since these too can generally only transmit tensile forces.

FIG. 6 shows a further feature at an envelope element 52 by way of example. At the distal end of the envelope elements 52, means for axially affixing the elastically bending connection element 53 (which is not shown here) can be arranged. Through the disc 55 shown here any sliding off of the elastically bending connection element 53 is avoided.

FIG. 7 shows a further embodiment in which the envelope elements 52 are formed as openings that are arranged about the circumference of the shafts 50, 51. Here, the elastically bending connection element 53 (which is not shown here) is braided alternatingly through these openings 53 to connect the concentric shafts 50, 51 to each other.

In the embodiments known so far, the shaft connection through the at least one elastically bending connecting means 53 was in the foreground. It generally forms an elastic coupling.

However, in general this connection can also be formed in terms of a mechanical securing device against any overloading, in particular overloading by torque. The elastically bending connecting means 53 can have a defined tear limit. If that is exceeded, e.g. through a defect in the gear 30, the elastically bending connecting means 53 tears, so that e.g. the output-side part, i.e. the second shaft 51, can rotate freely. This may be necessary to avoid blocking the fan 23 in the event of any damage.

FIG. 8 shows a further embodiment in which the envelope elements 52 are formed in such a manner that they have two elastically bending connecting means 53 arranged axially in the parallel planes E, E′; which an axial offset thus being present. According to a required torque transmission of the shafts 50, 51, the tensile stress of the two elastically bending connecting means 53 can be correspondingly adjusted, i.e. the elastically bending connecting means 53 do not have to be identical in E and E.

### PARTS LIST

9 rotational axis
10 aircraft engine
11 core engine
12 air inlet
14 compressor, low pressure compressor
15 high pressure compressor
16 combustion device
17 high pressure turbine
18 bypass duct discharge nozzle
19 turbine, low pressure turbine
20 core engine discharge nozzle
21 nacelle
22 bypass duct (subsidiary flow duct)
23 fan
24 stationary support structure
26 core engine shaft
27 connecting shaft
28 sun gear
30 planetary gear
32 planetary wheel
32′, 32″ planetary wheel elements
34 planetary carrier for planetary wheels
36 connections
38 ring gear
40 connections
50 first shaft
51 second shaft
52 envelope element
53 elastically bending connection element
54 opening in shaft for inserting the elastically bending connecting means
A flow through the core engine
B flow through the bypass duct
E. E′ plane of the elastically bending connection element
U overlapping area

1. A shaft arrangement with two concentrically arranged shafts, in particular two concentric hollow shafts that are coupled to the drive side or output side of an engine, wherein the shafts respectively have envelope elements that are connected with at least one elastically bending connection element, wherein the torque transmission between the concentric shafts is effected by tensile forces in the elastically bending envelope elements.

2. The shaft arrangement according to claim 1, wherein the at least one elastically bending connection element is formed as a rope, in particular a wire rope, as a chain or as a strap.

3. The shaft arrangement according to claim 1, wherein the at least one elastically bending connection element is formed in a ring-shaped, that is, infinite manner.

4. The shaft arrangement according to claim 1, wherein the at least one elastically bending connection element is guided around and/or wound around the envelope elements for connecting the shafts.

5. The shaft arrangement according to claim 1, wherein the at least one elastically bending connection element is arranged around the envelope elements without being crossed with itself or with other elastically bending connection elements.

6. The shaft arrangement according to claim 1, wherein, for connecting the concentric shafts, the at least one elastically bending connection element, in particular in the loaded state, is arranged in a plane that is located perpendicular to the rotational axis of the two concentric shafts.

7. The shaft arrangement according to claim 1, wherein the at least one connection element is affixed at an envelope element at maximally one position.

8. The shaft arrangement according to claim 1, wherein the envelope elements are arranged at the concentric shafts in such a manner that the at least one elastically bending connection element connected thereto is arranged in a plane that is perpendicular to the rotational axis of the two concentric shafts.

9. The shaft arrangement according to claim 1, wherein the envelope elements are arranged as projections at least at one of the concentric shafts in the axial direction, wherein the projections are in particular formed in one piece at the shaft ends.

10. The shaft arrangement according to claim 1, wherein the envelope elements of the at least one concentric shaft are formed at least partially by openings, in particular by pairs of openings, in particular by openings in concentric hollow shafts.

11. The shaft arrangement according to claim 1, wherein the at least one elastically bending connection element is formed as a mechanical securing device against overloading in order to protect the gear against blocking.

12. The shaft arrangement according to claim 1, wherein at least two elastically bending connection elements are arranged so as to be axially offset with respect to one another, wherein the at least two elastically bending connection elements in particular have different tensile strains.

13. The shaft arrangement according to claim 1, wherein between 5 and 30 envelope elements, in particular 10 envelope elements, are arranged at the concentric shafts at the circumference or at the shaft end.

14. The shaft arrangement according to claim 1, wherein the shaft arrangement mechanically connects two concentric shafts on the output side of an engine, in particular of a planetary gear, of a turbofan drive.

15. The shaft arrangement according to claim 1, wherein the shaft arrangement mechanically connects two concentric shafts on the drive side of an engine, in particular of a planetary gear, of a turbofan drive.

16. The shaft arrangement according to claim 1, wherein the envelope elements have a means for axially affixing the at least one elastically bending connection element.

17. The shaft arrangement according to claim 1, wherein the at least one elastically bending connection element and/or the envelope elements have a low-friction coating.

18. The shaft arrangement according to claim 1, wherein the envelope elements have at least one slide bearing.

19. The shaft arrangement according to claim 1, wherein the at least one elastically bending connecting means is formed as a wire rope, wherein the wire rope has a diameter of between 5 and 25 mm, in particular of between 10 and 20 mm.

20. An aircraft engine with
a core engine, comprising a turbine, a compressor and a core engine shaft for connecting the turbine to the compressor,
a fan upstream of the core engine, wherein the fan has a plurality of blades, and
a planetary gear that is connected to the core engine shaft on the entry side, and is connected to the fan on the exit side to the drive in such a manner that the rotational speed of the fan is lower than the rotational speed of the core engine shaft, and
with a shaft arrangement having the features of claim 1.
